(19) United States
(12) Patent Application Publication
(10) Pub. No.: US 2019/0047067 A1
(43) Pub. Date: Feb. 14, 2019

(54) Adhering Structure and Method of Different Materials

(71) Applicants: Hyundai Motor Company, Seoul (KR); Kia Motors Corporation, Seoul (KR)

(72) Inventors: Hyeon Jeong Ryu, Seoul (KR); Injune Kim, Suwon-si (KR)

(21) Appl. No.: 15/820,995

(22) Filed: Nov. 22, 2017

(30) Foreign Application Priority Data
Aug. 10, 2017 (KR) 10-2017-0101441

(51) Int. Cl. B23K 9/007; F16B 19/08

(52) U.S. Cl. CPC B23K 9/007; F16B 2019/045; F16B 19/08

(57) ABSTRACT

Disclosed herein is an adhering structure of different materials. The adhering structure can be used for integrally adhering a non-ferrous metal plate and a steel metal plate to each other. A tubular element is configured to penetrate through an adhesion hole of the non-ferrous metal plate and to support a surface of the steel metal plate. A welding part is formed in an internal hollow of the tubular element and includes an inner surface portion of the tubular element and forms a surface portion of the steel metal plate. The welding part is formed from a material that provides a molten pool of a filler metal during a welding process.

### CROSS-REFERENCE TO RELATED APPLICATIONS

This application claims priority to Korean Patent Application No. 10-2017-0101441, filed in the Korean Intellectual Property Office on Aug. 10, 2017, which application is hereby incorporated herein by reference.

### TECHNICAL FIELD

The present invention relates to an adhering structure of different materials.

### BACKGROUND

Recently, application of a light material to a configuration of a vehicle body has increased in order to increase fuel efficiency. As application of the light material has increased as described above, a combination of different materials, for example, aluminum and a steel material, or the like, has increased, but when welding is applied for adhesion of the combination of different materials as described above, a quality problem may occur due to galvanic corrosion.

In order to decrease the problem due to galvanic corrosion as described above, a non-melting type adhesion technology is required, but in order to utilize this non-melting type adhesion technology, all welding apparatuses in an existing adhesion process should be replaced, and thus, initial investment cost may be excessively increased.

Recently, in order to solve the above-mentioned problems, a welding method using a resistance spot welding (REW) apparatus has been applied to the vehicle body. However, an additional apparatus for supplying a separate steel element inserted for preventing galvanic corrosion is required in this REW apparatus, and respective equipment for supplying an element for each standard is required, such that there are problems in that a scale of process equipment as well as investment cost are increased. Further, an existing REW apparatus includes a moving device and a control device to have a complicate process, such that there is a difficulty in maintenance.

In addition, according to the related art, methods using a flow drill screw (FDS) and a blind rivet are applied as a method capable of performing adhesion of different materials in one-side direction. However, in these methods, separate equipment is also required, such that initial investment cost may be excessively increased.

The above information disclosed in this Background section is only for enhancement of understanding of the background of the invention and therefore it may contain information that does not form the prior art that is already known in this country to a person of ordinary skill in the art.

### SUMMARY

The present invention relates to an adhering structure of different materials. Particularly embodiments of the present invention relate to an adhering structure of different materials formed by adhering a non-ferrous metal plate and a steel metal plate to each other using a melting method, and an adhering method of different materials.

Embodiments of the present invention provide an adhering structure and method of different materials having advantages of using a tubular rivet as a steel element to adhere metal plates of different materials by an arc-welding melting method.

An exemplary embodiment of the present invention provides an adhering structure of different materials in which a non-ferrous metal plate and a steel metal plate are integrally adhered to each other. The adhering structure includes a steel tubular element penetrating an adhesion hole of the non-ferrous metal plate and supporting a surface of the steel metal plate. The adhering structure also includes a welding part formed in an internal hollow of the tubular element and including an inner surface portion of the tubular element, a surface portion of the steel metal plate, and a molten pool of a filler metal.

The tubular element may include a tubular rivet having the hollow.

The tubular element may include a head portion supporting a surface of the non-ferrous metal plate and a cylindrical shank portion having the hollow connected to the head portion, one end integrally connected to the head portion, and the other end supporting the surface of the steel metal plate.

The tubular element may include an aluminum or zinc plating layer coated on an outer surface thereof.

The welding part may be formed by an arc welding method using the filler metal.

The adhering structure of different materials may further include an adhesive layer provided between overlapping surfaces of the non-ferrous metal plate and the steel metal plate.

The steel metal plate may be any one of a steel sheet, a stainless steel sheet, a high-tensile strength steel sheet, and a super high-tensile strength steel sheet.

The non-ferrous metal plate may be any one of an aluminum plate or a magnesium plate.

Another embodiment of the present invention provides an adhering method of different materials for adhering metal plates of different materials, a non-ferrous metal plate and a steel metal plate, to each other. The adhering method includes (a) processing an adhesion hole in the non-ferrous metal plate; (b) setting the non-ferrous metal plate on a surface of the steel metal plate so as to overlap each other; (c) inserting a steel tubular element into the adhesion hole of the non-ferrous metal plate; and (d) arc-welding an inner surface portion of the tubular element and a surface portion of the steel metal plate while melting a filler metal in an internal hollow of the tubular element using an arc welding apparatus.

In step (c), the tubular element may include a tubular rivet having an outer surface on which an aluminum or zinc plating layer is coated.

In step (c), the tubular element may include a head portion; and a cylindrical shank portion having the hollow connected to the head portion and one end integrally connected to the head portion.

In step (c), the head portion may support a surface of the non-ferrous metal plate, and the other end of the shank portion may support the surface of the steel metal plate.

In step (d), the filler metal having a wire shape may be supplied to the internal hollow of the tubular element and melted by arc, and the inner surface portion of the tubular element and the surface portion of the steel metal plate may be melted by the arc.

In step (d), a welding part including the inner surface portion of the tubular element, the surface portion of the steel metal plate, and a molten pool of the filler metal may be formed in the internal hollow of the tubular element.

In step (b), a structural adhesive may be applied onto at least one of overlapping surfaces of the non-ferrous metal plate and the steel metal plate.

According to an embodiment of the present invention, unlike the related art in which metal plates of different materials are adhered using a REW method, a FDS method, and a blind rivet method, the metal plates of different materials may be adhered to each other by the arc welding melting method using the steel tubular rivet.

Therefore, in the exemplary embodiments of the present invention, since the metal plates of different materials are adhered to each other using the existing arc welding apparatus without using a REW apparatus, a FDS apparatus, and a blind rivet apparatus, which are relatively expensive, and peripheral equipment for utilizing these apparatus, a process may be simple, and equipment investment cost may be decreased.

Other effects that may be obtained or are predicted by an exemplary embodiment of the present invention will be explicitly or implicitly described in a detailed description of the present invention. That is, various effects that are predicted according to an exemplary embodiment of the present invention will be described in the following detailed description.

### BRIEF DESCRIPTION OF THE DRAWINGS

The accompanying drawings are provided in order to describe exemplary embodiments of the present invention, such that technical idea of the present invention is not limited to the accompanying drawings.

FIG. 1 is a perspective diagram illustrating an adhering structure of different materials according to an exemplary embodiment of the present invention.

FIG. 2 is a cross-sectional configuration diagram illustrating the adhering structure of different materials according to the exemplary embodiment of the present invention.

FIG. 3 is a perspective diagram illustrating a tubular element applied to the adhering structure of different materials according to the exemplary embodiment of the present invention.

FIGS. 4 to 7 are diagrams for explaining an adhering method of different materials according to another exemplary embodiment of the present invention.

### DETAILED DESCRIPTION OF ILLUSTRATIVE EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In order to clarify the present invention, parts that are not connected with the description will be omitted, and the same elements or equivalents are referred to with the same reference numerals throughout the specification.

The size and thickness of each element are arbitrarily shown in the drawings, but the present invention is not necessarily limited thereto, and in the drawings, the thickness of portions, regions, etc. are exaggerated for clarity.

Moreover, the use of the terms first, second, etc. are used to distinguish one element from another, and are not limited to the order in the following description.

Throughout the present specification, unless explicitly described to the contrary, the word “comprise” and variations such as “comprises” or “comprising” will be understood to imply the inclusion of stated elements but not the exclusion of any other elements.

Further, the terms ‘unit’, ‘means’, ‘-er (-or)’, ‘member’, etc., described in the specification indicate a configuration unit for performing at least one function or operation.

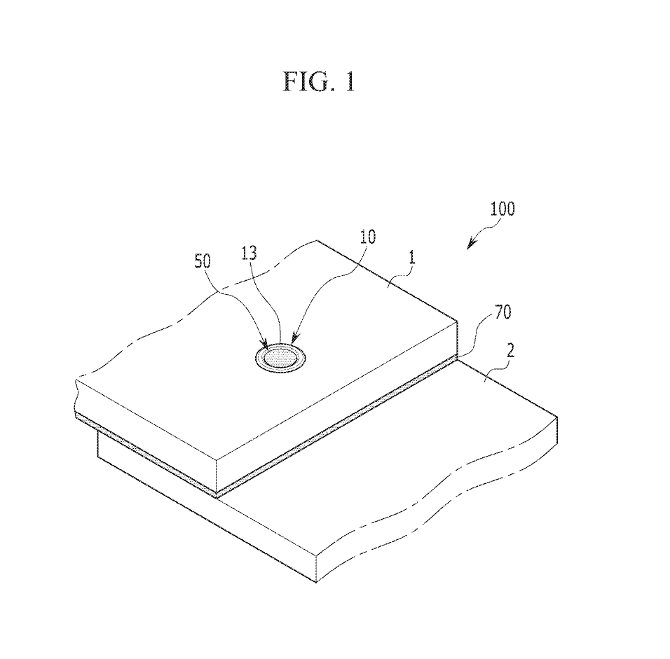

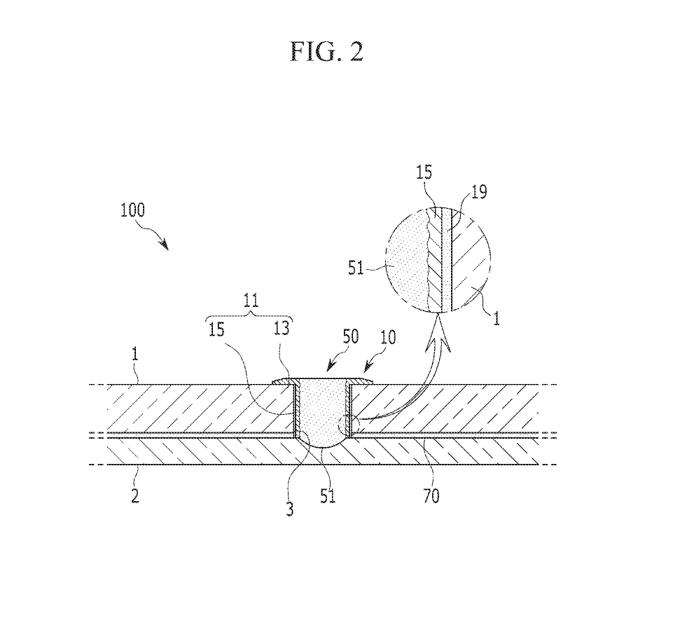

FIG. 1 is a perspective diagram illustrating an adhering structure of different materials according to an exemplary embodiment of the present invention, and FIG. 2 is a cross-sectional configuration diagram illustrating the adhering structure of different materials according to the exemplary embodiment of the present invention.

Referring to FIGS. 1 and 2, the adhering structure 100 of different materials according to the exemplary embodiment of the present invention, which is an adhesion body in which metal plates 1 and 2 of different materials are integrally adhered to each other in order to promote lightness of a vehicle body, may be configured, for example, as a component for assembling a vehicle body such as a vehicle body panel.

This adhering structure 100 of different materials is not limited to being applied to the vehicle body panel as described above, but may also be applied to various vehicle body structures such as members for a vehicle body, a vehicle body frame, and the like.

Further, the scope of the present invention is not necessarily limited to the adhering structure of different materials of a component for assembling a vehicle body, but the technical spirit of the present invention may also applied to adhering structures of different material as long as they are applied to various kinds of structures for various purposes.

Here, the metal plates 1 and 2 of different materials may be a non-ferrous metal plate 1 such as an aluminum plate, a magnesium plate, and the like and a steel metal plate 2 such as a steel sheet, a stainless steel sheet, a high-tensile strength steel sheet, a super high-tensile strength steel sheet, and the like.

Hereinafter, a case of manufacturing the adhering structure of different materials by integrally adhering the non-ferrous metal plate 1 and the steel metal plate 2 in a vertical direction in a state in which the non-ferrous metal plate 1 is disposed on the steel metal plate to overlap each other based on the accompanying drawings will be described.

However, since definition of the above-mentioned direction is a relative definition, and the direction may be changed depending on a reference position of the non-ferrous metal plate 1 and the steel metal plate 2, an adhesion direction of an adhesion apparatus, and the like, the above direction is not necessarily limited as a reference direction of the present exemplary embodiment.

The adhering structure boo of different materials according to the exemplary embodiment of the present invention has a structure in which the metal plates 1 and 2 of different materials are adhered to each other by an arc welding melting method using a tubular rivet as a steel element.

Specifically, the adhering structure 100 of different materials according to the exemplary embodiment of the present invention as described above includes a tubular element 10 and a welding part 50 as illustrated in FIGS. 1 and 2.

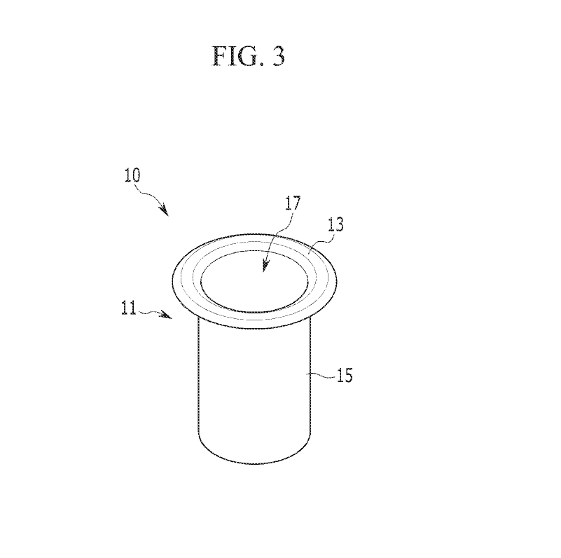

In the exemplary embodiment of the present invention, the tubular element 10 includes a steel tubular rivet having the internal hollow 17 as illustrated in FIG. 3. The tubular element 10 as the tubular rivet 11 supports a surface (an upper surface in the accompanying drawings) of the steel metal plate 2 while penetrating through an adhesion hole 3 (generally referred to as a “pre-hole” in the art) formed in the non-ferrous metal plate 1.

This tubular element 10 includes a head portion 13 and a shank portion 15, which are basic configurations of a rivet. The head portion 13, which supports the surface (the upper surface in the accompanying drawings) of the non-ferrous metal plate 1, is provided in a circular flange shape.

The shank portion 15 has the internal hollow 17 connected to the head portion 13 and is provided in a cylindrical shape having one end (an upper end in the accompanying drawings) integrally connected to a lower surface of the head portion 13 and the other end penetrating through the adhesion hole 3 of the non-ferrous metal plate 1 to support the surface (the upper surface in the accompanying drawings) of the steel metal plate 2.

That is, the head portion 13 forms an open end connected to the internal hollow 17 of the shank portion 15 and supports the upper surface of the non-ferrous metal plate 1 through the lower surface thereof. In addition, the shank portion 15 is provided in a form of a hollow shaft integrally connected to an edge portion of the open end at the lower surface of the head portion 13.

Meanwhile, the tubular element 10 includes an aluminum or zinc plating layer 19 coated on an outer surface thereof as illustrated in FIG. 2. The reason of coating the outer surface of the tubular element 10 with aluminum plating (ALMAC) or zinc plating (ZnNi) as described above is to prevent galvanic corrosion caused by coupling of different materials, that is, the steel tubular element 10 and the non-ferrous metal plate 1.

In the exemplary embodiment of the present invention, the welding part 50, which is a part integrally adhering the tubular element 10 and the steel metal plate 2 to each other as illustrated in FIGS. 1 and 2, may be formed by an arc welding method using a filler metal. That is, the welding part 50 is provided as an arc welding part formed by arc-welding the tubular element 10 and the steel metal plate 2 using the filler metal.

The welding part 50 as described above is formed toward an internal hollow 17 (see FIG. 3) of the tubular element 10, and includes a hollow inner surface portion of the tubular element 10, a surface portion (upper surface portion in the accompanying drawings) of the steel metal plate, and a molten pool 51 of the filler metal.

Meanwhile, the adhering structure 100 of different materials according to the exemplary embodiment of the present invention further includes an adhesive layer 70 as well as the above-mentioned welding part 50 in order to further increase adhesion performance between the non-ferrous metal plate 1 and the steel metal plate 2.

In the exemplary embodiment of the present invention, the adhesive layer 70, which is to adhere the non-ferrous metal plate 1 and the steel metal plate 2 to each other, may be provided by curing a structural adhesive widely used and known in the art at a set temperature for a set time.

The adhesive layer 70 as described above is provided between overlapping surfaces of the non-ferrous metal plate 1 and the steel metal plate 2, that is, between the lower surface of the non-ferrous metal plate 1 and the upper surface of the steel metal plate 2, and serves to integrally adhere the non-ferrous metal plate 1 and the steel metal plate 2 to each other.

Hereinafter, an adhering method of different materials for manufacturing the adhering structure 100 of different material according to the exemplary embodiment of the present invention, configured as described above will be described in detail with reference to the accompanying drawings.

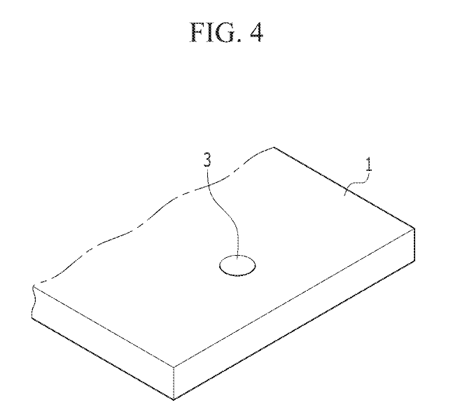

FIGS. 4 to 7 are diagrams for explaining an adhering method of different materials according to an exemplary embodiment of the present invention.

Referring to FIG. 4, first, in the exemplary embodiment of the present invention, a non-ferrous metal plate 1 is provided, and an adhesion hole 3 as an adhesion site is processed in the non-ferrous metal plate 1. The adhesion hole 3 may be formed by a piercing tool known in the art, and a plurality of adhesion holes may be formed depending on strength, a size, and the like, of the non-ferrous metal plate 1.

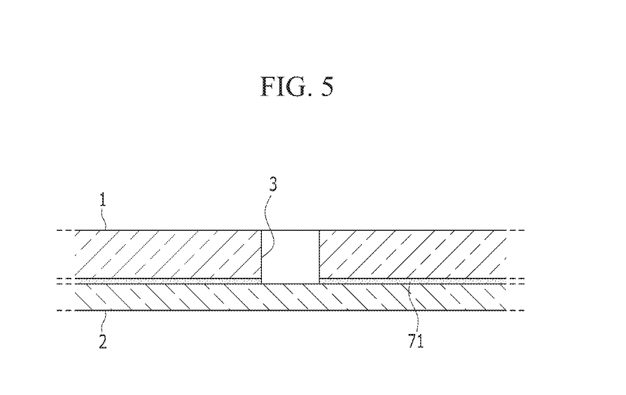

Next, in the exemplary embodiment of the present invention, as illustrated in FIG. 5, a steel metal plate 2 to be adhered to the non-ferrous metal plate 1 in which the adhesion hole 3 is processed is provided, and a lower surface of the non-ferrous metal plate 1 is set on an upper surface of the steel metal plate 2 so as to overlap each other.

In the exemplary embodiment of the present invention, a structural adhesive 71 is applied onto at least one surface of overlapping surfaces of the non-ferrous metal plate 1 and the steel metal plate 2, that is, the lower surface of the non-ferrous metal plate 1 or the upper surface of the steel metal plate 2 in the above-mentioned process.

Further, in the exemplary embodiment of the present invention, the lower surface of the non-ferrous metal plate 1 is set on the upper surface of the steel metal plate 2 so as to overlap each other in the above-mentioned state. Therefore, non-ferrous metal plate 1 and the steel metal plate 2 are maintained in a state in which they are adhered to each other by the structural adhesive 71.

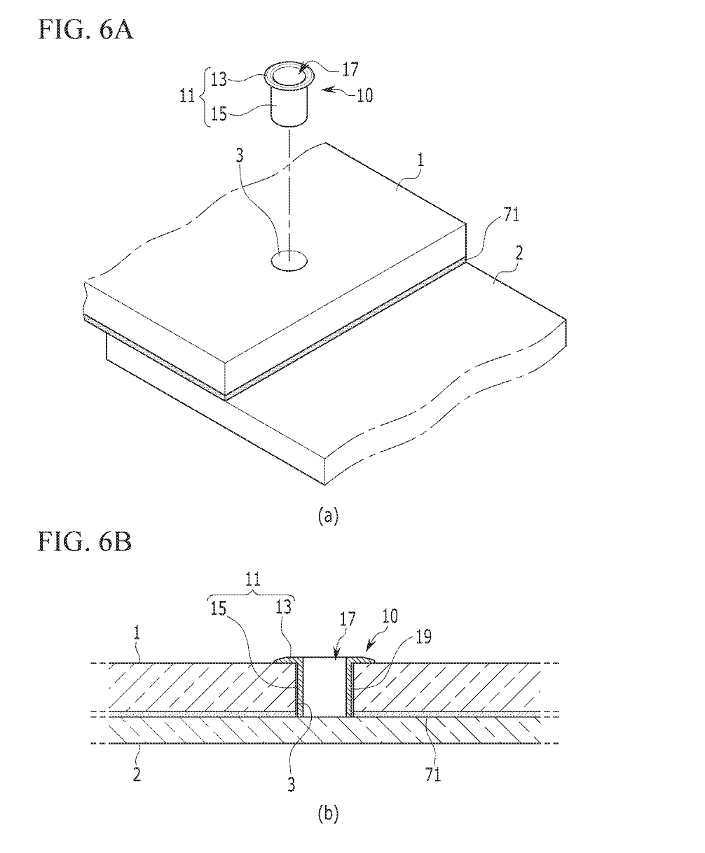

In the exemplary embodiment of the present invention, as illustrated in FIGS. 6A and 6B, a steel tubular element 10 is provided and inserted into the adhesion hole 3 of the non-ferrous metal plate 1 in this state. In the exemplary embodiment of the present invention, a tubular rivet 11 having the internal hollow 17 is provided as the tubular element 10.

This tubular rivet 11 includes a head portion 13 in a circular flange shape and a cylindrical shank portion 15 having the internal hollow 17 connected to the head portion 13 and an upper end integrally connected to a lower surface of the head portion 13.

Here, the head portion 13 supports the upper surface of the non-ferrous metal plate 1 through the lower surface thereof, and the lower end of the shank portion 15 supports the upper surface of the steel metal plate 2. Further, an aluminum or zinc plating layer 19 is formed on an outer surface of the tubular rivet 11.

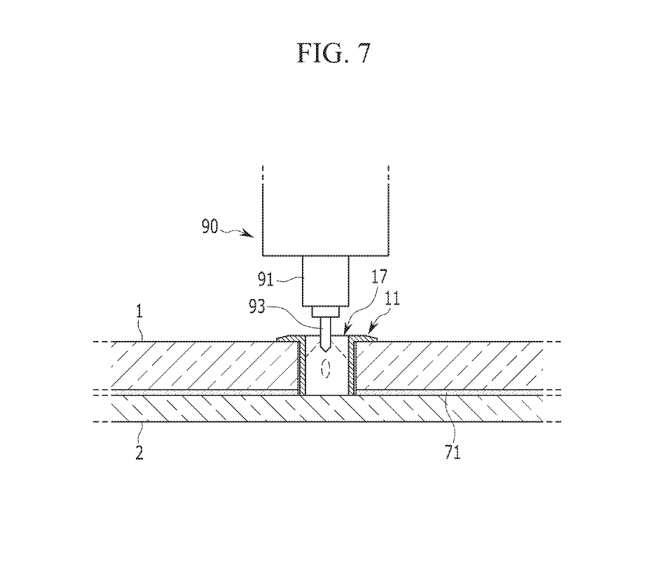

Next, in the exemplary embodiment of the present invention, an arc welding apparatus 90 is provided as illustrated in FIG. 7. The arc welding apparatus 90 includes a torch head 91 including a welding tip, a gas nozzle, and the like, and a wire supply part (not illustrated) supplying a filler metal 93 as a metal wire to the torch head 91.

Since this arc welding apparatus 90 includes components of an arc welding system well known in the art, a detailed description of the configurations will be omitted.

Therefore, in the exemplary embodiment of the present invention, when the filler metal 93 approaches to the internal hollow 17 of the tubular rivet 11 under a protection gas atmosphere, the filler metal 93 is melted by arc heat generated at this time, and at the same time, the hollow inner surface portion of the tubular rivet 11 and the surface portion of the steel metal plate 2 are arc-welded to each other.

When the filler metal 93 is supplied to the internal hollow 17 of the tubular rivet 11 through the wire supply part in this process, filler metal 93 is melted by the arc heat, and at the same time, the hollow inner surface portion of the tubular rivet 11 and the surface portion of the steel metal plate 2 are melted by the arc heat.

Then, in the exemplary embodiment of the present invention, as illustrated in FIG. 2, the welding part 50 including the hollow inner surface portion of the tubular rivet 11, the surface portion of the steel metal plate 2, and the molten pool 51 of the filler metal 93 (see FIG. 7) is formed in the internal hollow 17 (see FIG. 7) of the tubular rivet 11. That is, the welding part 50 is provided as the arc welding part integrally adhering the shank portion 15 of the tubular rivet 11 and the steel metal plate 2 to each other by the molten pool 51.

Here, since the aluminum or zinc plating layer 19 is coated on the outer surface of the tubular element 10, it is possible to prevent galvanic corrosion caused by coupling of the steel tubular rivet 11 and the non-ferrous metal plate 1.

In the exemplary embodiment of the present invention, after the welding part 50 is cooled for a set time in a state in which the tubular rivet 11 and the steel metal plate 2 are arc-welded to each other as described above, the structural adhesive 71 adhering the non-ferrous metal plate 1 and the steel metal plate 2 to each other as illustrated in FIG. 7 is cured at a set temperature for a set time.

Therefore, in the exemplary embodiment of the present invention, an adhesive layer 70 adhering the non-ferrous metal plate 1 and the steel metal plate 2 to each other is formed between the lower surface of the non-ferrous metal plate and the upper surface of the steel metal plate 2.

Therefore, in the exemplary embodiment of the present invention, heterogeneous adhesion between the non-ferrous metal plate 1 and the steel metal plate 2 may be performed by integrally adhering the shank portion 15 of the tubular rivet 11 and the steel metal plate 2 through the weld part 50 while supporting the upper surface of the non-ferrous metal plate 1 through the head portion 13 of the tubular rivet 11.

According to the exemplary embodiment of the present invention as described above, unlike the related art in which metal plates of different materials are adhered using a REW method, a FDS method, and a blind rivet method, the metal plates 1 and 2 of different materials may be adhered to each other by the arc welding melting method using the steel tubular rivet 11.

Therefore, in the exemplary embodiment of the present invention, since the metal plates 1 and 2 of different materials are adhered to each other using the existing arc welding apparatus 90 instead of using a REW apparatus, a FDS apparatus, and a blind rivet apparatus, which are relatively expensive, and peripheral equipment for utilizing these apparatus, a process may be simple, and equipment investment cost may be decreased.

Further, in the exemplary embodiment of the present invention, as the shank portion 15 of the tubular rivet 11 coupled to the non-ferrous metal plate 1 through the head portion 13 is arc-welded to the steel metal plate 2, a high-quality adhesion product of different materials having high tension-shear strength may be secured.

Hereinabove, although exemplary embodiments of the present invention are described, the spirit of the present invention is not limited to the embodiments set forth herein and those skilled in the art and understanding the present invention can easily accomplish other embodiments included in the spirit of the present invention by the addition, modification, and removal of components within the same spirit, but those are construed as being included in the spirit of the present invention.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An adhering structure for integrally adhering a non-ferrous metal plate and a steel metal plate to each other, the adhering structure comprising:
a tubular element configured to penetrate through an adhesion hole of the non-ferrous metal plate and support a surface of the steel metal plate; and
a welding part formed in an internal hollow of the tubular element and including an inner surface portion of the tubular element, the welding part to form a surface portion of the steel metal plate, wherein the welding part is formed from a material that provides a molten pool of a filler metal during a welding process.

2. The adhering structure of claim 1, wherein the tubular element includes a tubular rivet having the hollow.

3. The adhering structure of claim 1, wherein the tubular element includes:
a head portion configured to support a surface of the non-ferrous metal plate; and
a cylindrical shank portion having the hollow connected to the head portion, one end integrally connected to the head portion, and an opposite end configured to support the surface of the steel metal plate.

4. The adhering structure of claim 1, wherein the tubular element includes an aluminum or zinc plating layer coated on an outer surface thereof.

5. The adhering structure of claim 1, wherein the welding part is formed by an arc welding process that uses the filler metal.

6. The adhering structure of claim 1, further comprising an adhesive layer provided between overlapping surfaces of the non-ferrous metal plate and the steel metal plate.

7. The adhering structure of claim 1, wherein the steel metal plate comprises a steel sheet, a stainless steel sheet, a high-tensile strength steel sheet, or a super high-tensile strength steel sheet.

8. The adhering structure of claim 1, wherein the non-ferrous metal plate comprises an aluminum plate or a magnesium plate.

9. An apparatus comprising:
a non-ferrous metal plate;
a steel metal plate attached to the non-ferrous metal plate;
a tubular element penetrating through an adhesion hole of the non-ferrous metal plate and supporting a surface of the steel metal plate; and
a welding part formed in an internal hollow of the tubular element and including an inner surface portion of the tubular element, a surface portion of the steel metal plate, wherein the welding part is formed from a material that provides a molten pool of a filler metal during a welding process.

10. The apparatus of claim 9, wherein the tubular element includes a tubular rivet having the hollow.

11. The apparatus of claim 9, wherein the tubular element includes:
a head portion supporting a surface of the non-ferrous metal plate; and
a cylindrical shank portion having the hollow connected to the head portion, one end of the cylindrical shank portion integrally connected to the head portion and an opposite end of the cylindrical shank portion supporting the surface of the steel metal plate.

12. The apparatus of claim 9, wherein the tubular element includes an aluminum or zinc plating layer coated on an outer surface thereof.

13. The apparatus of claim 9, further comprising an adhesive layer provided between overlapping surfaces of the non-ferrous metal plate and the steel metal plate.

14. A method for adhering a non-ferrous metal plate and a steel metal plate, the method comprising:
forming an adhesion hole in the non-ferrous metal plate;
setting the non-ferrous metal plate on a surface of the steel metal plate so that the non-ferrous metal plate overlaps the steel metal plate;
inserting a steel tubular element into the adhesion hole of the non-ferrous metal plate; and
arc-welding an inner surface portion of the tubular element and a surface portion of the steel metal plate while melting a filler metal in an internal hollow of the tubular element.

15. The method of claim 14, wherein the tubular element comprises a tubular rivet having an outer surface coated with an aluminum or zinc plating layer.

16. The method of claim 14, wherein the tubular element comprises a head portion and a cylindrical shank portion having the hollow connected to the head portion, one end of the cylindrical shank portion being integrally connected to the head portion.

17. The method of claim 16, wherein the head portion supports a surface of the non-ferrous metal plate, and a second end of the cylindrical shank portion supports the surface of the steel metal plate.

18. The method of claim 14, wherein the arc-welding comprises:
supplying a filler metal having a wire shape to the internal hollow in the tubular element; and
melting the inner surface portion of the tubular element and the surface portion of the steel metal plate by an arc of the arc-welding.

19. The method of claim 18, wherein a welding part that includes the inner surface portion of the tubular element, the surface portion of the steel metal plate, and a molten pool of the filler metal are formed in the internal hollow of the tubular element during the arc-welding.

20. The method of claim 14, further comprising applying a structural adhesive at overlapping surfaces of the non-ferrous metal plate and the steel metal plate prior to setting the non-ferrous metal plate on the surface of the steel metal plate.
